(19) United States
(12) Patent Application Publication
(10) Pub. No.: US 2026/0027830 A1
(43) Pub. Date: Jan. 29, 2026

(54) CLEANING METHOD FOR INKJET PRINT HEAD AND FLUID DISCHARGING APPARATUS

(71) Applicant: Mizuki Kuroha, Kanagawa (JP)

(72) Inventor: Mizuki Kuroha, Kanagawa (JP)

(73) Assignee: Ricoh Company, Ltd., Tokyo (JP)

(21) Appl. No.: 19/277,915

(22) Filed: Jul. 23, 2025

(30) Foreign Application Priority Data
Jul. 25, 2024 (JP) 2024-119552

(51) Int. Cl. B41J 2/165; C09D 11/033

(52) U.S. Cl. CPC B41J 2/16552; C09D 11/033; B41J 2002/16558; B41P 2235/21

(57) ABSTRACT

A cleaning method for an inkjet print head includes rubbing the ink discharging surface of the inkjet print head that discharges an ink with a wiper blade, wherein the ink is an oil-based ink containing a coloring material and a solvent mixture, the solvent mixture including an ester-based solvent represented by the following Chemical Formula 1 accounting for 5 to 70 percent by mass of the organic solvents and a saturated hydrocarbon solvent accounting for 20 to 80 percent by mass of the organic solvents, wherein the solvent mixture includes organic solvents having a boiling point of at least 100 degrees Celsius accounting for at least 70 percent by mass of the ink, wherein the wiper blade includes nitrile rubber containing at least 30 percent by mass of acrylonitrile,

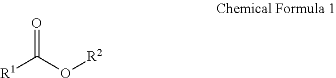

where R¹ and R² each independently represent a linear or branched, saturated or unsaturated aliphatic alkyl group.

### CROSS-REFERENCE TO RELATED APPLICATIONS

This patent application is based on and claims priority pursuant to 35 U.S.C. § 119 to Japanese Patent Application No. 2024-119552, filed on Jul. 25, 2024, in the Japan Patent Office, the entire disclosure of which is hereby incorporated by reference herein.

### BACKGROUND

### Technical Field

The present disclosure is related to a cleaning method for an inkjet print head and a fluid discharging apparatus.

### Description of the Related Art

Inkjet printing produces text and images on printing media by directly discharging ink droplets from extremely fine nozzles to attach the ink droplets to the printing media.

Image forming utilizing inkjet printing is widely used in industrial settings.

Moreover, advancements in inkjet technology have enabled high-speed printing. Such high performance requires ink having an excellent drying property and fixability to produce text and images having high image quality.

In particular, oil-based inks utilizing low-volatile or non-volatile organic solvents as primary components have attracted increasing attention due to their enhanced penetration into printing media, which reduces the energy required for drying. Additionally, these inks demonstrate excellent resistance to nozzle clogging.

In inkjet apparatuses, fine nozzles can become contaminated by dust and debris from inside or outside the device, paper fibers from the printing medium, or dried ink particles. This contamination can reduce the ink discharging stability. Therefore, cleaning methods in which the ink discharging surface of the inkjet print head is wiped using a wiper blade are widely employed.

The wiper blade comes into contact with ink when the inkjet print head is wiped. As a result, the organic solvents contained in the ink may cause the rubber of the wiper blade to swell, thereby lowering its elastic modulus. Moreover, with repeated wiping, this can lead to deformation and wear, eventually reducing the ink removal performance.

This problem is particularly pronounced with oil-based or solvent-based inks that use organic solvents as their primary component, as opposed to water-based inks that use water as the main component. Therefore, when typical wipers made from rubbers with low solvent resistance, such as EPDM-typically used for water-based inks, are used with oil-based or solvent-based inks, the ink removal performance may deteriorate prematurely due to rubber degradation.

### SUMMARY

The present disclosure described herein provides a cleaning method for an inkjet print head which includes rubbing the ink discharging surface of the inkjet print head that discharges an ink with a wiper blade, wherein the ink is an oil-based ink containing a coloring material and a solvent mixture, the solvent mixture including an ester-based solvent represented by the following Chemical Formula 1 accounting for 5 to 70 percent by mass of the organic solvents and a saturated hydrocarbon solvent accounting for 20 to 80 percent by mass of the organic solvents, wherein the solvent mixture includes organic solvents having a boiling point of at least 100 degrees Celsius accounting for at least 70 percent by mass of the ink, wherein the wiper blade includes nitrile rubber containing at least 30 percent by mass of acrylonitrile,

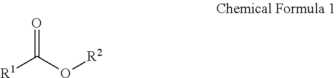

where R¹ and R² each independently represent a linear or branched, saturated or unsaturated aliphatic alkyl group.

As another aspect of the present disclosure, the present disclosure described herein provides a fluid discharging apparatus includes an ink, an inkjet print head to discharge the ink through nozzles, and a wiper blade to rub an ink discharging surface of the inkjet print head, wherein the ink is an oil-based ink containing a coloring material and a solvent mixture, the solvent mixture including an ester-based solvent represented by the following Chemical Formula 1 accounting for 5 to 70 percent by mass of the organic solvents and a saturated hydrocarbon solvent accounting for 20 to 80 percent by mass of the organic solvents, wherein the solvent mixture includes organic solvents having a boiling point of at least 100 degrees Celsius accounting for at least 70 percent by mass of the ink, wherein the wiper blade includes nitrile rubber containing at least 30 percent by mass of acrylonitrile,

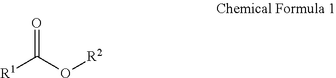

where R¹ and R² each independently represent a linear or branched, saturated or unsaturated aliphatic alkyl group.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating a perspective view of an example of the inkjet printing apparatus in which the cover of the ink container mounting unit is open;

FIG. 2 is a schematic diagram illustrating the entire configuration of the inkjet printing apparatus; and

FIG. 3 is a diagram illustrating a partial enlarged cross sectional view of the inkjet printing apparatus illustrated in FIG. 1.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present disclosure, a cleaning method is provided that can maintain effective ink removal performance on the ink discharging surface of an inkjet print head.

Embodiments of the present disclosure are described in detail below.

The present disclosure relates to a cleaning method for an inkjet print head, and more particularly, to a cleaning method for an ink discharging surface of the inkjet print head by wiping it with a wiper blade.

The ink used in the present disclosure is an oil-based ink containing at least 70 percent by mass of a solvent mixture other than water, the mixture having a boiling point of at least 100 degrees Celsius. The ink contains, as the solvent mixture, from 5 to 70 percent by mass of an ester-based solvent having a structure represented by the following Chemical Formula 1, and from 20 percent by mass to 80 percent by mass of a saturated hydrocarbon solvent.

The ink is an oil-based ink containing a coloring material and the solvent mixture containing organic solvents. The organic solvents contain from 5 to 70 percent by mass of an ester-based solvent having a structure represented by the Chemical Formula 1 below, and from 20 to 80 percent by mass of a saturated hydrocarbon solvent. The total content of the organic solvents having a boiling point of at least 100 degrees Celsius in the ink is at least 70 percent by mass.

The wiper blade includes nitrile rubber containing at least 30 percent by mass of acrylonitrile.

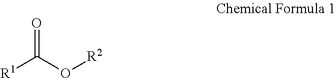

In the Chemical Formula 1, R¹ and R² each independently represent a linear or branched, saturated or unsaturated aliphatic alkyl group)

The oil-based ink for use in the present disclosure is described.

### Ink

The organic solvents, coloring materials, resins, and additives for use in the ink are described below.

### Organic Solvent

If the Hansen solubility parameter (HSP) value of the organic solvent in the ink becomes too high, it approaches the HSP value of the nitrile rubber, thereby tending to cause swelling and deterioration of the nitrile rubber. Accordingly, it is preferable that the HSP value be at most 17.0 (J/cm²)^{0.5}, and more preferably at most 16.5 (J/cm²)^{0.5}.

### Hansen Solubility Parameter

The Hansen Solubility Parameter (HSP) is represented in a three dimensional space using three components of the dispersion component (δD), polarity component (δP), and hydrogen bond component (δH) obtained by dividing the solubility parameter (SP) introduced by Hidebrand. The dispersion component (δD) represents the effect by the dispersion force, the polarity component (δP) represents the effect by the dipole force, and the hydrogen bond component (δH) represents the effect by the hydrogen bonding strength.

The three components of the Hansen solubility parameter (HSP) and the solubility parameter (SP value) are related by the following equation:

$$S {P}^{2} = δ {D}^{2} + δ {P}^{2} + δ {H}^{2}$$

That is, the SP value corresponds to the vector length of the HSP components.

The definition and calculation of the HSP are described in the following document.

The solubility parameter (HSP) values (δD, δP, and δH) of solvents, as described by Charles M. Hansen in Hansen Solubility Parameters: A User's Handbook (CRC Press, 2007), can be conveniently estimated from their chemical structures using, for example, the computer software Hansen Solubility Parameters in Practice (HSPiP).

In the present disclosure, the values of the solvents registered in the database of HSPiP version 5.4.08 are used as they are and the values of the solvents not registered in the database are estimated by HSPiP version 5.4.08.

### Solvent Mixture

In the present disclosure, the ink used employs a solvent mixture as the solvent.

The term “solvent mixture” refers to all solvents contained in the ink. The three Hansen solubility parameters (HSP values) of the solvent mixture (δD, δP, and δH) can each be calculated as a weighted average based on the volume fraction of each component in the solvent mixture and the respective HSP values (δD, δP, and δH) of each component.

The type and the percentage of a solvent mixture can be identified by gas chromatography-mass spectrometry (GCMS). Specifically, the entire ink is subjected to GCMS for qualitative analysis of the solvents contained therein. Once the types of solvents are identified, calibration curves for the concentration of each organic solvent can be plotted, and the content of each organic solvent in the ink can be quantitatively determined.

The organic solvents used in the present disclosure contains an organic solvent having a boiling point of at least 100 degrees Celsius, and the content of organic solvents with a boiling point of at least 100 degrees Celsius in the ink is at least 70 percent by mass.

For the oil-based ink, it is preferable that the weight loss after heating at 150 degrees Celsius for 1 hour be less than 20 percent by mass. This requirement is to prevent changes in ink properties due to volatilization, ensure stable inkjet printing, and maintain high image quality.

The boiling point of the organic solvent is preferably at least 100 degrees Celsius, more preferably at least 150 degrees Celsius, and even more preferably at least 200 degrees Celsius. It should be noted that the organic solvents having a boiling point of at least 250 degrees Celsius include those that do not exhibit a distinct boiling point.

The amount of the organic solvent can be adjusted as appropriate. Preferably, the organic solvent is contained in an amount of at least 70 percent by mass relative to the entire of the ink, and more preferably at least 80 percent by mass.

The ink used in the present disclosure contains, as an organic solvent, an ester-based solvent represented by the following Chemical Formula 1.

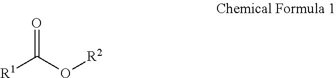

In the Chemical Formula 1, R¹ and R² each independently represent a linear or branched, saturated or unsaturated aliphatic alkyl group).

Ester-based solvents have relatively high δP and δH values in terms of Hansen solubility parameters (HSP), which are relatively close to those of nitrile rubber. As a result, they exhibit good wettability to nitrile rubber. The inclusion of such ester-based solvents therefore enhances ink removal performance when the ink is wiped with a nitrile rubber wiper blade. Moreover, due to their high surface tension, ester-based solvents reduce the penetration speed of the ink into printing media, thereby contributing to higher image density. On the other hand, if the content of ester-based solvents in the ink becomes too high, they may cause swelling and degradation of nitrile rubber.

Specific examples of the ester-based solvents include, but are not limited to:
phthalic acid esters such as dibutyl phthalate, dicapryl phthalate, diisodecyl phthalate, dioctyl phthalate (DOP), diisononyl phthalate, dioctyl phthalate, and butyl-2-ethylhexyl phthalate, di-2-ethylhexyl phthalate; lauric acid esters such as methyl laurate, ethyl laurate, and isobutyl laurate; myristic acid esters such as isopropyl myristate, isocetyl myristate, and octyldodecyl myristate; palmitic acid esters such as isopropyl palmitate and octyl palmitate; octanoic acid esters such as cetyl octanoate, octyl octanoate (2-ethylhexyl 2-ethylhexanoate: OOE), and isononyl octanoate; isononanoic acid esters such as 2-ethylhexyl isononanoate and isononyl isononanoate; and oleic acid esters such as butyl oleate and ethyl oleate. These can be used alone or in combination.

The content of the ester-based solvent is preferably from 5 to 70 percent by mass, more preferably from 20 to 50 percent by mass, based on the entire of the ink.

The organic solvents contain a hydrocarbon solvent. Hydrocarbon solvents have low δP and δH components in their Hansen solubility parameters (HSP values), and are relatively distant from the HSP values of nitrile rubber. Accordingly, they are less likely to cause degradation of nitrile rubber. Among hydrocarbon solvents, saturated hydrocarbon solvents are preferred because they are less likely to degrade nitrile rubber.

Specific examples include, but are not limited to, aliphatic hydrocarbon solvents such as octane, nonane, decane, undecane, dodecane, tridecane, and tetradecane; and commercial solvents such as: 0 Solvent L, 0 Solvent M, 0 Solvent H, Cactus Normal Paraffin N-10, N-11, N-12, N-13, N-14, N-15H, YHNP, SHNP, Isozol 300, Isozol 400, Techlean N-16, N-20, N-22, AF Solvent No. 4, No. 5, No. 6, No. 7, Naphtesol 160, 200, 220 (all manufactured by ENEOS Corporation); and Isopar G, H, L, M; Exxsol D40, D60, D80, D95, D110, D130 (all manufactured by ExxonMobil Chemicals Co., Ltd.), which include paraffinic solvents, naphthenic solvents, and isoparaffinic solvents.

The content of the saturated hydrocarbon solvent is preferably from 20 to 80 percent by mass, more preferably from 20 to 50 percent by mass, based on the entire of the ink.

In addition to ester-based solvents and saturated hydrocarbon solvents, the organic solvent may further include solvents such as alcohol-based solvents, fatty acid-based solvents, and ether-based solvents.

Examples include, but are not limited to: higher alcohol-based solvents having six or more carbon atoms in a molecule, preferably from 12 to 20, such as isomyristyl alcohol, isopalmityl alcohol, isostearyl alcohol, oleyl alcohol, isoarachidyl alcohol, and decyltetradecanol; higher fatty acid-based solvents having at least 12 carbon atoms in a molecule, preferably from 14 to 20, such as lauric acid, isomyristic acid, palmitic acid, isopalmitic acid, α-linolenic acid, linoleic acid, oleic acid, and isostearic acid; and ether-based solvents, such as diethylene glycol monobutyl ether, ethylene glycol monobutyl ether, propylene glycol monobutyl ether, and propylene glycol dibutyl ether.

The water content in the ink is preferably at most 1 percent by mass relative to the entire of the ink, more preferably less than 1 percent by mass, even more preferably at most 0.5 percent by mass, and furthermore preferably at most 0.1 percent by mass.

### Coloring Material

The coloring material has no particular limitation and includes such materials as a pigment and a dye.

The pigment includes an inorganic pigment or organic pigment. These can be used alone or in combination. Also, mixed crystals are usable as the pigments.

Examples of the pigments include, but are not limited to, black pigments, yellow pigments, magenta pigments, cyan pigments, white pigments, green pigments, orange pigments, and gloss or metallic pigments of gold, silver, and others.

Carbon black available from known methods such as contact methods, furnace methods, and thermal methods can be used as the inorganic pigment in addition to titanium oxide, iron oxide, calcium carbonate, barium sulfate, aluminum hydroxide, barium yellow, cadmium red, and chrome yellow.

Specific examples of the organic pigments include, but are not limited to, azo pigments, polycyclic pigments (e.g., phthalocyanine pigments, perylene pigments, perinone pigments, anthraquinone pigments, quinacridone pigments, dioxazine pigments, indigo pigments, thioindigo pigments, isoindolinone pigments, and quinophthalone pigments), dye chelates (e.g., basic dye type chelates and acid dye type chelates), nitro pigments, nitroso pigments, and aniline black. Of these pigments, pigments with high affinity with solvents are preferable. Hollow resin particles and hollow inorganic particles can also be used.

Specific examples of the pigments for black include, but are not limited to, carbon black (C.I. Pigment Black 7) such as furnace black, lamp black, acetylene black, and channel black, metals such as copper, iron (C.I. Pigment Black 11), and titanium oxide, and organic pigments such as aniline black (C.I. Pigment Black 1).

Specific examples of the pigments for color include, but are not limited to, C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 138, 150, 153, 155, 180, 185, and 213; C.I. Pigment Orange 5, 13, 16, 17, 36, 43, and 51, C.I. Pigment Red 1, 2, 3, 5, 17, 22, 23, 31, 38, 48:2, 48:2 {Permanent Red 2B(Ca)}, 48:3, 48:4, 49:1, 52:2, 53:1, 57:1 (Brilliant Carmine 6B), 60:1, 63:1, 63:2, 64:1, 81, 83, 88, 101 (rouge), 104, 105, 106, 108 (Cadmium Red), 112, 114, 122 (Quinacridone Magenta), 123, 146, 149, 166, 168, 170, 172, 177, 178, 179, 184, 185, 190, 193, 202, 207, 208, 209, 213, 219, 224, 254, and 264; C.I. Pigment Violet 1 (Rhodamine Lake), 3, 5:1, 16, 19, 23, and 38; C.I. Pigment Blue 1, 2, 15 (Phthalocyanine Blue), 15:1, 15:2, 15:3, 15:4, (Phthalocyanine Blue), 16, 17:1, 56, 60, and 63, C.I. Pigment Green 1, 4, 7, 8, 10, 17, 18, and 36.

The dye is not particularly limited and includes, for example, acidic dyes, direct dyes, reactive dyes, basic dyes. These can be used alone or in combination.

Specific examples of the dye include, but are not limited to, C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C. I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

The proportion of the coloring material in ink is preferably from 0.1 to 15 percent by mass and more preferably from 1 to 10 percent by mass to enhance the image density, fixability, and discharging stability.

### Pigment Dispersion

In order to stably disperse the pigment in the ink, a pigment dispersant may be used together with the pigment.

The dispersant mentioned above can be suitably selected in accordance with a particular application.

Specific examples include, but are not limited to, polyamide, polyurethane, polyester, polyurea, epoxy resins, polycarbonate, urea resins, melamine resins, phenol resins, polysaccharides, gelatine, gum arabic, dextran, casein, protein, natural rubber, carboxy polymethylene, polyvinyl alcohol, polyvinyl pyrrolidone, polyvinyl acetate, polyvinyl chloride, polyvinylidene chloride, cellulose, ethyl cellulose, methyl cellulose, nitro cellulose, hydroxyethyl cellulose, cellulose acetate, polyethylene, polystyrene, polymers or copolymers of (meth)acrylic acid, polymers or copolymers of (meth)acrylic acid esters, copolymers of (meth)acrylic acids-(meth)acrylic acid esters, copolymers of styrene-maleic acid, sodium alginate, aliphatic acid, paraffin, bee wax, water wax, hardened beef tallow, carnauba wax, and albumin, or copolymers thereof. These can be used alone or in combination. Among these, resin-based dispersants containing nitrogen atoms, such as polyamides, are preferred.

Commercially available products can be used as the dispersant. Specific examples of such commercial products include, but are not limited to, SOLSPERSE™ 11200 and SOLSPERSE™ 13940 (both available form Lubrizol Japan Limited). These can be used alone or in combination.

The proportion of the dispersant to the entire of ink is preferably from 3 to 7 percent by mass and more preferably from 4 to 5 percent by mass. If the content is between 3 to 7 percent by mass, it can prevent the aggregation of colorant, typically dispersed pigments, and improve dispersion stability.

### Additive

The ink may optionally contain additives such as surfactants, defoaming agents, preservatives and antifungal agents, anti-clogging agents for nozzles, antioxidants, conductivity modifiers, viscosity modifiers, surface tension modifiers, and oxygen absorbers.

The particle diameter of the solid portion in an ink has no particular limit and can be selected to suit to a particular application. The maximum frequency of the particle diameter of the solid portion in the ink is preferably from 20 to 1000 nm and more preferably from 20 to 150 nm in the maximum number conversion to enhance discharging stability and image quality such as image density. The solid content includes particles such as resin particles and pigment particles. The particle diameter can be measured by using a particle size analyzer (Nanotrac Wave-UT151, available from MicrotracBEL Corp).

Properties of the ink are not particularly limited and they can be suitably selected to suit to a particular application. The ink preferably has properties, such as viscosity, surface tension, and pH, in the following ranges.

The ink preferably has a viscosity of from 5 to 30 mPa·s and more preferably from 5 to 25 mPa·s at 25 degrees Celsius to enhance the print density and text quality and achieve good dischargeability. Viscosity can be measured with equipment such as a rotatory viscometer, RE-80L, available from TOKI SANGYO CO., LTD. The measuring conditions are as follows:
Standard cone rotor (1° 34′×R24)
Sample liquid amount: 1.2 mL
Rate of rotations: 50 rotations per minute (rpm)
25 degrees Celsius
Measuring time: three minutes.

The surface tension of the ink is preferably at most 35 mN/m and more preferably at most 32 mN/m at 25 degrees Celsius because the ink suitably levels on a recording medium and the ink dries in a short time.

### Wiper Blade

The material of the wiper blade used in the present disclosure is preferably nitrile rubber (NBR). Nitrile rubber, a copolymer of butadiene and acrylonitrile, is widely used due to its relatively good oil resistance among rubbers.

The acrylonitrile-butadiene rubber (NBR) used in the present disclosure can be synthesized by various methods. There is no particular limitation, as long as the material exhibits rubber-like elasticity at room temperature, allowing a wide range of NBR materials to be employed.

It is known that higher acrylonitrile content results in better oil resistance.

Nitrile rubber is classified by acrylonitrile content as follows:

Low nitrile: less than 24 percent, Medium nitrile: 24 to 30 percent, Medium-high nitrile: 30 to 36 percent, High nitrile: 36 to 42 percent, and Ultra-high nitrile: over 42 percent.

This can be explained by the fact that higher acrylonitrile content increases the δP and δH components of the Hansen Solubility Parameter (HSP), thereby improving resistance to solvents such as hydrocarbon solvents, which have smaller δP and δH components. Therefore, an acrylonitrile content of at least 30 percent is preferred, and at least 36 percent is even more preferable.

Procurable nitrile rubbers that meet these requirements include “NIPOL” from ZEON Corporation, “JSR-N” from JSR Corporation, and “CHEMIGUM” from The Goodyear Tire & Rubber Company.

The wiper blade may optionally contain, in addition to the rubber component, various additives such as reinforcing agents, vulcanizing agents, vulcanization accelerators, vulcanization auxiliaries, and anti-aging agents.

There are no particular limitations on the method used to obtain the compound by mixing these materials. For example, the components may be mixed using kneading equipment such as roll mills, propeller mixers, or kneader mixers.

The method of molding the wiper blade is also not particularly limited, and examples include, but are not limited to, injection molding and compression molding.

When wiping the ink discharging surface of an inkjet print head with the wiper blade to remove ink, the ink is transferred from the ink discharging surface to the wiper blade. Therefore, better wettability of the wiper blade with respect to the ink results in higher ink removal performance.

### Printing Medium

The printing medium for use in printing is not particularly limited. Specific examples include, but are not limited to, plain paper, glossy paper, special paper, cloth, film, transparent sheets, and printing paper for general purposes.

### Printed Matter

The ink printed matter related to the present disclosure includes a printing medium and an image formed on the printing medium with the ink of the present disclosure.

The printed matter is obtained by an inkjet printing device that executes an inkjet printing method.

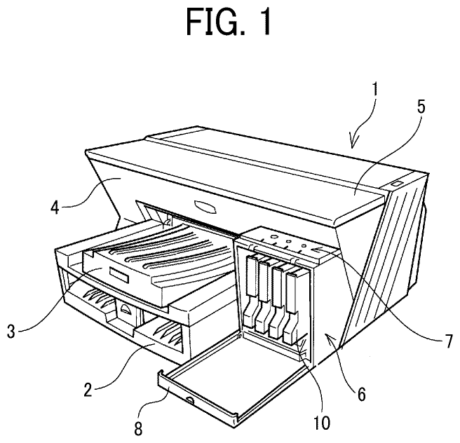

Embodiments of the present disclosure are described with reference to the accompanying drawings. One example of an image forming apparatus, which includes a maintenance unit for a fluid discharging apparatus of the present disclosure, will be described with reference to FIG. 1. FIG. 1 is a perspective view of the image forming apparatus as seen from the front side.

This image forming apparatus includes an image forming apparatus 1, a sheet feed tray 2 mounted to the image forming apparatus 1 for loading sheets, and a sheet ejection tray 3 also mounted to the image forming apparatus 1 for storing sheets on which images have been printed (formed). Additionally, at one end of the front surface 4 of the image forming apparatus 1, a cartridge loading unit 6 protrudes forward from the front surface 4 and is positioned lower than a top surface 5. An operation unit 7, including operation keys and a display, is arranged on the upper surface of the cartridge loading unit 6. A tank 10, which serves as a liquid storage tank functioning as a liquid replenishment device (hereinafter referred to as an “ink cartridge”), is removably mounted in the cartridge loading unit 6. The cartridge is also equipped with a front cover 8 that can be opened and closed.

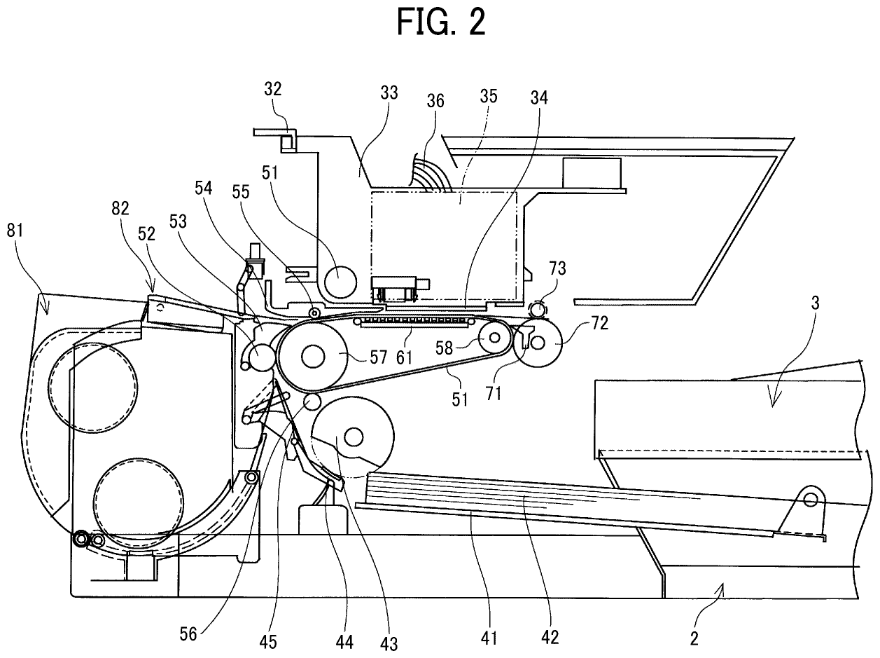

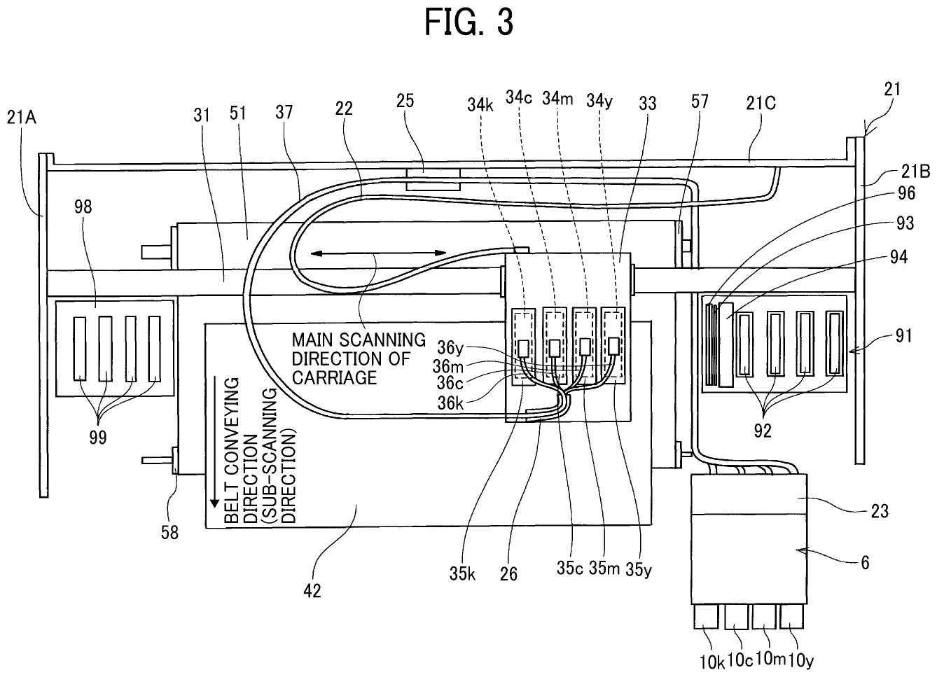

Next, the mechanical section of this image forming apparatus will be described with reference to FIGS. 2 and 3. FIG. 2 is a schematic diagram illustrating the overall configuration of the mechanical section, and FIG. 3 is a plan view illustrating the components of the mechanical section.

A carriage 33 is slidably supported in the main scanning direction by a stay 32 and a guide rod 31 serving as a guide member laterally bridged between left and right plates, i.e., a side plate 221A and a side plate 221B that constitute a frame 21. The carriage 33 scans in the direction (carriage scanning direction-main scanning direction) indicated by the arrow in FIG. 3 by a main scanning motor.

A plurality of print heads 34, which are inkjet print heads serving as droplet discharging heads for discharging printing fluid droplets (ink droplets), are mounted on the carriage 33. These print heads 34 are arranged such that their multiple nozzles are aligned in a direction intersecting the main scanning direction, and are mounted with their multiple nozzles facing downward.

The print heads 34 include, for example: a print head 34y that discharges yellow (Y) droplets, a print head 34m that discharges magenta (M) droplets, a print head 34c that discharges cyan (C) droplets, and a print head 34b that discharges black (Bk) droplets. Note that the term “print head 34” refers to a head regardless of color unless otherwise specified.

The head configuration is not limited to the above examples and may also be constructed using one or more print heads, each having one or more nozzle arrays for discharging ink droplets of one or more colors.

As the droplet discharging heads that form the print head 34, it is possible to use a device having an energy-generating device to discharge ink such as a piezoelectric actuator such as a piezoelectric element, a thermal actuator that utilizes the phase change caused by film boiling of liquid using an electric heat conversion element such as a heat element, a shape-memory alloy actuator that uses the metal phase change due to the temperature change, and an electrostatic actuator that uses an electrostatic force.

This print head 34 carries a driver IC and is connected to a control unit through a harness (flexible print (FPC) cable) 22 as illustrated in FIG. 3.

Sub-tanks 35y, 35m, 35c, and 35k (collectively referred to as “sub-tank 35” when color distinction is not made) are mounted.

As illustrated in FIG. 3, each of these sub-tanks 35y, 35m, 35c, and 35k is supplied with printing liquid from the corresponding ink cartridges 10y, 10m, 10c, and 10k (collectively referred to as “ink cartridge 10” when color distinction is not made) via a printing fluid supply tube 37, which is composed of four tubes-36y, 36m, 36c, and 36k (collectively referred to as “tube 36” when color distinction is not made). Each individual tube 36 is also a printing liquid supply tube.

As also illustrated in FIG. 3, the ink cartridge 10 is housed in the cartridge loading unit 6. This cartridge loading unit 6 is provided with a supply pump unit 23 for delivering the printing fluid from inside the ink cartridge 10.

Additionally, the printing fluid supply tube 37, which extends from the ink cartridge loading unit 6 to the sub-tank 35, is securely held in place by a main-body side holder 25 on a rear plate 21C that forms part of the frame 21 during its routing.

Furthermore, it is also secured on the carriage 33 by a fixing rib 26.

A sheet feeding unit for feeding a sheet 42 loaded on a sheet loader (or base plate) 41 of a sheet feed tray 2 includes a half-moon shape roller (sheet feeding roller) 43 to separate and feed the sheet 42 one by one from the sheet loader 41 and a separation pad 44 made of a material having a large friction index and arranged facing the sheet feeding roller 43 while being biased towards the sheet feeding roller 43.

A conveyance unit conveys the sheet 42, which is fed from the sheet feeding unit, below the print head 34.

This conveyance unit includes:
a conveyor belt 51 that electrostatically adsorbs and conveys the sheet 42;
a counter roller 52 that pinches the sheet 42 together with the conveyor belt 51 and conveys it via a guide 45;
a conveying guide 53 that changes the conveying direction of the sheet 142, turning it approximately 90 degrees from a substantially vertical upward path to a horizontal path as it moves onto the conveyor belt 51; and
a front end pressing roller 55, which is biased toward the conveyor belt 51 by a pressure member 54. In addition, a charging roller 56 as a charger is disposed to charge the surface of the conveyor belt 51.

The conveyor belt 51 is an endless form belt, stretched between a conveying roller 57 and a tension roller 58 and rotatable in the belt conveying direction indicated in FIG. 3. This charging roller 56 is arranged to be in contact with the top layer of the conveyor belt 51 in order to be rotationarily driven to the rotation of the conveyor belt 51. Also, a pressure of 2.5N is applied to both ends of the shaft of the charging roller 56.

On the rear side of the conveyor belt 51, a guiding member 61 is disposed corresponding to the print region by the print head 54. The guiding member 61 protrudes toward the print head 34 side beyond the tangent line connecting the two rollers (the conveying roller 57 and the tension roller 58) that support the conveyor belt 51 on its upper surface.

Furthermore, the sheet ejection unit ejects the sheet 42, on which an image is printed by the print head 34. This unit includes a separation claw 71 for separating the sheet 42 from the conveyor belt 51, a sheet ejection roller 72, and a sheet ejection roller 73. The sheet ejection tray 3 is located below the sheet ejection roller 72. The sheet ejection tray 3 is arranged to be considerably low from between the sheet ejection roller 72 and the sheet ejection roller 73 to increase the amount of the sheet 42 stacked on the sheet ejection tray 3.

A duplex sheet feeding unit 81 is mounted in a detachable and attachable manner to the rear side of the image forming apparatus 1.

The duplex sheet feeding unit 81 takes in the sheet 42 returned by the reverse rotation of the conveyor belt 51, reverses it, and feeds it again between the counter roller 52 and the conveyor belt 51. A bypass sheet feeding unit 82 is provided on the upper surface of the duplex sheet feeding unit 81.

As illustrated in FIG. 3, a reliability maintenance and recovery mechanism 91 is arranged in the non-printing area on one side of the carriage 33 in the scanning direction. This mechanism includes a maintenance device relating to the present disclosure for maintaining and recovering the condition of the nozzles of the print head 34.

The maintenance and recovery mechanism 91 includes a cap 92 for capping each ink discharging surface of the print head 34, a wiper blade 93 as a blade member for wiping the ink discharging surface, a dummy discharging receiver 94 for receiving droplets discharged during purge (which discharges droplets not contributing to printing to expel thickened print fluid), and a wiper cleaner 95 integrally formed with the dummy discharging receiver 94 as a cleaning member for removing printing fluid adhered to the wiper blade 93. Additionally, it includes a cleaner roller 96 that constitutes a cleaning device to press the wiper blade 93 against the wiper cleaner 95 during cleaning of the wiper blade 93.

In addition, as illustrated in FIG. 3, in the non-printing area on the opposite side of the carriage 33 in the main scanning direction, a dummy discharge receiver 98 is arranged to receive droplets discharged not for printing but for dummy discharge, which is performed to expel thickened printing fluid during operation. The dummy discharge receiver 98 includes openings 99 formed along the nozzle array direction of the print head 34.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

The present disclosure is described in detail below referring to Examples and Comparative Examples, but is not limited thereto.

### Preparation of Ink

Each component was mixed according to the formulation shown in Table 2, and then the mixture was dispersed in a bead mill for about 20 minutes to obtain ink.

The trade names and the manufacturing companies of the ingredients shown in Table 2 are as follows:
Black Pigment 1: Carbon Black MA8 (available from Mitsubishi Chemical Corporation)
Pigment Dispersant 1: SOLSPERSE™ 13940 (available from Lubrizol Japan Co., Ltd.)
Ester Solvent 1: Ethyl Oleate (available from Tokyo Chemical Industry Co., Ltd., boiling point 209 degrees Celsius/10 mmHg)
Ester Solvent 2: Isopropyl Palmitate (available from Tokyo Chemical Industry Co., Ltd., boiling point 160 degrees Celsius/2 mmHg)
Ester Solvent 3: Ethyl Acetate (available from Tokyo Chemical Industry Co., Ltd., boiling point 77 degrees Celsius)
Alcohol Solvent 1: Hexadecanol (available from Tokyo Chemical Industry Co., Ltd., boiling point 344 degrees Celsius)
Saturated Hydrocarbon Solvent 1: Dodecane (available from FUJIFILM Wako Pure Chemical Corporation, boiling point 216 degrees Celsius)
Unsaturated Hydrocarbon Solvent 1: p-Xylene (available from FUJIFILM Wako Pure Chemical Corporation, boiling point 138 degrees Celsius)

### Wiper Blade

Using a roll mixer, each component was sequentially mixed at the ratios shown in Table 1 and kneaded at 80 degrees Celsius for 10 minutes.

The unit for the formulation ratios of each component in Table 1 is “parts by mass.”

The resulting compound was press-molded to produce a rubber sheet with a thickness of 1.5 mm by performing primary vulcanization (160 degrees Celsius, 10 minutes, press pressure 120 kgf/mm²) and secondary vulcanization (150 degrees Celsius, 4 hours, no pressure). This sheet was then cut to obtain wiper blades 1 to 3.

The trade names and manufacturers of the components in Table 1 are as follows:
Nitrile Rubber 1: Nipol DN003 (available from Zeon Corporation, acrylonitrile content 50 percent by mass)
Nitrile Rubber 2: Nipol DN212 (available from Zeon Corporation, acrylonitrile content 33.5 percent by mass)
Nitrile Rubber 3: Nipol DN401 (available from Zeon Corporation, acrylonitrile content 18.0 percent by mass)
Carbon Black: Seast ISAF (available from Tokai Carbon Co., Ltd.)
Zinc Oxide: Zinc Oxide Type 2 (available from Mitsui Mining & Smelting Co., Ltd.)
Stearic Acid: Tsubaki (available from Nihon Yushi Co., Ltd.)
Anti-aging Agent 1: Nocrack CD (available from OUCHI SHINKO CHEMICAL INDUSTRIAL CO., LTD.)
Anti-aging Agent 2: Nocrack MB (available from OUCHI SHINKO CHEMICAL INDUSTRIAL CO., LTD.)
Vulcanization Accelerator 1: Nocceler DM-P (available from OUCHI SHINKO CHEMICAL INDUSTRIAL CO., LTD.)
Vulcanization Accelerator 2: Nocceler TS (available from Ouchi Shinko Chemical Industry Co., Ltd.)
Sulfur: Powdered sulfur (available from Tsurumi Chemical Industry Co., Ltd.)

### SP Value of Solvent Mixture

The Hansen solubility parameters (HSP values: δD, δP, δH) of each solvent constituting the solvent mixture solvent were obtained from literature values, and the HSP values of the solvent mixture were calculated as a weighted average. Furthermore, the solubility parameter (SP) value of the solvent mixture was calculated using the following equation:

$$SP value = {( δ {D}^{2} + δ {P}^{2} + δ {H}^{2} )}^{0.5}$$

### Evaluation on Fixability

The inks and wiper blades were mounted in an inkjet printer (RICOH SG5200), and after performing the cleaning operation, the ink discharging surface of the inkjet print head was visually inspected and evaluated according to the following criteria.

### Evaluation Criteria

The wiping performance was evaluated according to the following criteria. Grades S and A are allowable.
S: Ink is almost completely removed.
A: Slight ink residue is observed.
C: Clear ink residue remains.

### Swelling Ratio Measurement

The swelling ratio of the wiper blade in the ink was measured based on JIS K6258 (Rubber, vulcanized or thermoplastic-Determination of the Effect of Liquids).

The wiper blade was cut into pieces measuring 10×5×2 mm and fully immersed in ink for 72 hours. The swelling ratio was calculated from the mass change before and after immersion.

$$Swelling ratio = ( ( w 2 - w 1 ) / w 1 ) \times 100 ( percent )$$

w1: Initial mass of the wiper blade (g)
w2: Mass of the wiper blade after 72 hours of immersion (g)

### Evaluation Criteria

The swelling ratio was evaluated according to the following criteria. S and A ratings are considered passing.
S: Swelling ratio is less than 25 percent.
A: Swelling ratio is 25 to less than 50 percent.
C: Swelling ratio is at least 50 percent

The evaluation results are shown in Table 2.

TABLE 1

| | | Wiper | Wiper | Wiper |
|---|---|---|---|---|
| Component | | blade | blade | blade |
| category | Component | 1 | 2 | 3 |
| Nitrile rubber | Nitrile rubber | 100 | | |
| | 1 | | | |
| | Nitrile rubber | | 100 | |
| | 2 | | | |
| | Nitrile rubber | | | 100 |
| | 3 | | | |
| Additive | Carbon black | 25 | 25 | 25 |
| | Zinc oxide | 5 | 5 | 5 |
| | Stearic acid | 1 | 1 | 1 |
| | Anti-aging | 1 | 1 | 1 |
| | agent 1 | | | |
| | Anti-aging | 2 | 2 | 2 |
| | agent 2 | | | |
| | Vulcanization | 1.5 | 1.5 | 1.5 |
| | Accelerator 1 | | | |
| | Vulcanization | 0.5 | 0.5 | 0.5 |
| | Accelerator 2 | | | |
| | Sulfur | 1.5 | 1.5 | 1.5 |

TABLE 2

| | Component | | Example No. | | | | |
|---|---|---|---|---|---|---|---|
| | category | Component | 1 | 2 | 3 | 4 | 5 |
| Ink | Pigment | Black pigment 1 | 5 | 5 | 5 | 5 | 5 |
| formulation | Pigment | Pigment | 5 | 5 | 5 | 5 | 5 |
| | dispersant | dispersion 1 | | | | | |
| | Solvent | Ester-based | 45 | 22 | 68 | | 40 |
| | | solvent 1 | | | | | |
| | | Ester-based | | | | 45 | |
| | | solvent 2 | | | | | |
| | | Ester-based | | | | | |
| | | solvent 3 | | | | | |
| | | Saturated | 45 | 68 | 22 | 45 | 40 |
| | | hydrocarbon | | | | | |
| | | solvent 1 | | | | | |
| | | Unsaturated | | | | | |
| | | hydrocarbon | | | | | |
| | | solvent 1 | | | | | |
| | | Alcohol-based | | | | | 10 |
| | | solvent 1 | | | | | |
| | | Total content of | 90 | 90 | 90 | 90 | 90 |
| | | solvent (percent | | | | | |
| | | by mass) | | | | | |
| | | Total content of | 90 | 90 | 90 | 90 | 90 |
| | | solvents having a | | | | | |
| | | boiling point of | | | | | |
| | | at least 100 | | | | | |
| | | degrees Celsius | | | | | |
| | | other than water | | | | | |
| | | SP value of | 16.3 | 16.1 | 16.6 | 16.3 | 16.5 |
| | | solvent mixture | | | | | |
| | Total (Percent by mass) | | 100 | 100 | 100 | 100 | 100 |
| Wiper blade | | Wiper blade 1 | A | A | A | A | A |
| | | Wiper blade 2 | | | | | |
| | | Wiper blade 3 | | | | | |
| Evaluation | Wiping | Interpretation | S | A | S | S | S |
| results | property | | | | | | |
| | Swelling | Interpretation | S | S | A | S | S |
| | ratio | | | | | | |

| | Component | | Example No. | | | |
|---|---|---|---|---|---|---|
| | category | Component | 6 | 7 | 8 | 9 |
| Ink | Pigment | Black pigment 1 | 5 | 5 | 5 | 5 |
| formulation | Pigment | Pigment | 5 | 5 | 5 | 5 |
| | dispersant | dispersion 1 | | | | |
| | Solvent | Ester-based | 45 | 5 | 70 | |
| | | solvent 1 | | | | |
| | | Ester-based | | | | |
| | | solvent 2 | | | | |
| | | Ester-based | | | | 20 |
| | | solvent 3 | | | | |
| | | Saturated | 45 | 80 | 20 | 70 |
| | | hydrocarbon | | | | |
| | | solvent 1 | | | | |
| | | Unsaturated | | | | |
| | | hydrocarbon | | | | |
| | | solvent 1 | | | | |
| | | Alcohol-based | | 5 | | |
| | | solvent 1 | | | | |
| | | Total content of | 90 | 90 | 90 | 90 |
| | | solvent (percent | | | | |
| | | by mass) | | | | |
| | | Total content of | 90 | 90 | 90 | 70 |
| | | solvents having a | | | | |
| | | boiling point of | | | | |
| | | at least 100 | | | | |
| | | degrees Celsius | | | | |
| | | other than water | | | | |
| | | SP value of | 16.3 | 16.1 | 16.7 | 16.1 |
| | | solvent mixture | | | | |
| | Total (Percent by mass) | | 100 | 100 | 100 | 100 |
| Wiper blade | | Wiper blade 1 | | A | A | A |
| | | Wiper blade 2 | A | | | |
| | | Wiper blade 3 | | | | |
| Evaluation | Wiping | Interpretation | S | A | S | A |
| results | property | | | | | |
| | Swelling | Interpretation | A | S | A | A |
| | ratio | | | | | |

| | Component | | Comparative Example No. | | | | |
|---|---|---|---|---|---|---|---|
| | category | Component | 1 | 2 | 3 | 4 | 5 |
| Ink | Pigment | Black pigment 1 | 5 | 5 | 5 | 5 | 5 |
| formulation | Pigment | Pigment | 5 | 5 | 5 | 5 | 5 |
| | dispersant | dispersion 1 | | | | | |
| | Solvent | Ester-based | 90 | | 45 | 45 | |
| | | solvent 1 | | | | | |
| | | Ester-based | | | | | |
| | | solvent 2 | | | | | |
| | | Ester-based | | | | | 25 |
| | | solvent 3 | | | | | |
| | | Saturated | | 90 | | 45 | 30 |
| | | hydrocarbon | | | | | |
| | | solvent 1 | | | | | |
| | | Unsaturated | | | 45 | | |
| | | hydrocarbon | | | | | |
| | | solvent 1 | | | | | |
| | | Alcohol-based | | | | | 35 |
| | | solvent 1 | | | | | |
| | | Total content of | 90 | 90 | 90 | 90 | 90 |
| | | solvent (percent | | | | | |
| | | by mass) | | | | | |
| | | Total content of | 90 | 90 | 90 | 90 | 65 |
| | | solvents having a | | | | | |
| | | boiling point of | | | | | |
| | | at least 100 | | | | | |
| | | degrees Celsius | | | | | |
| | | other than water | | | | | |
| | | SP value of | 17.1 | 16.0 | 17.5 | 16.3 | 17.2 |
| | | solvent mixture | | | | | |
| | Total (Percent by mass) | | 100 | 100 | 100 | 100 | 100 |
| Wiper blade | | Wiper blade 1 | A | A | | | A |
| | | Wiper blade 2 | | | A | | |
| | | Wiper blade 3 | | | | A | |
| Evaluation | Wiping | Interpretation | S | C | S | S | S |
| results | property | | | | | | |
| | Swelling | Interpretation | C | S | C | C | C |
| | ratio | | | | | | |

From the evaluation results shown in Table 2 above, it is understood that a cleaning method achieving both good wiping performance of the inkjet print head and a low swelling ratio of the wiper blade was obtained.

The aspects of the present disclosure are, for example, as follows:

### Aspect 1

A cleaning method for an inkjet print head includes rubbing the ink discharging surface of the inkjet print head that discharges an ink with a wiper blade, wherein the ink is an oil-based ink containing a coloring material and a solvent mixture, the solvent mixture including an ester-based solvent represented by the following Chemical Formula 1 accounting for 5 to 70 percent by mass of the organic solvents and a saturated hydrocarbon solvent accounting for 20 to 80 percent by mass of the organic solvents, wherein the solvent mixture includes organic solvents having a boiling point of at least 100 degrees Celsius accounting for at least 70 percent by mass of the ink, wherein the wiper blade includes nitrile rubber containing at least 30 percent by mass of acrylonitrile,

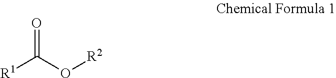

where R¹ and R² each independently represent a linear or branched, saturated or unsaturated aliphatic alkyl group.

### Aspect 2

The method according to Aspect 1 mentioned above, wherein the wiper blade immersed in the ink has a swelling ratio of at most 25 percent.

### Aspect 3

The method according to Aspect 1 or 2 mentioned above, wherein the solvent mixture in the ink has a solubility parameter (SP) of at most 17.0 (J/cm³)^{0.5}.

### Aspect 4

A fluid discharging apparatus includes an ink, an inkjet print head to discharge the ink through nozzles, and a wiper blade to rub an ink discharging surface of the inkjet print head, wherein the ink is an oil-based ink containing a coloring material and a solvent mixture, the solvent mixture including an ester-based solvent represented by the following Chemical Formula 1 accounting for 5 to 70 percent by mass of the organic solvents and a saturated hydrocarbon solvent accounting for 20 to 80 percent by mass of the organic solvents, wherein the solvent mixture includes organic solvents having a boiling point of at least 100 degrees Celsius accounting for at least 70 percent by mass of the ink, wherein the wiper blade includes nitrile rubber containing at least 30 percent by mass of acrylonitrile,

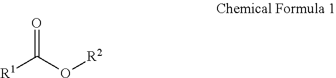

where R¹ and R² each independently represent a linear or branched, saturated or unsaturated aliphatic alkyl group.

### Aspect 5

The apparatus according to Aspect 4 mentioned above, wherein the wiper blade immersed in the ink has a swelling ratio of at most 25 percent.

### Aspect 6

The apparatus according to Aspect 4 or 5 mentioned above, wherein the solvent mixture in the ink has a solubility parameter (SP) of at most 17.0 (J/cm³)^{0.5}.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A cleaning method for an inkjet print head, comprising:
rubbing an ink discharging surface of the inkjet print head that discharges an ink with a wiper blade,
wherein the ink is an oil-based ink comprising a coloring material and a solvent mixture, the solvent mixture comprising:
an ester-based solvent represented by the following Chemical Formula 1 accounting for 5 to 70 percent by mass of the organic solvents; and
a saturated hydrocarbon solvent accounting for 20 to 80 percent by mass of the organic solvents,
wherein the solvent mixture includes organic solvents having a boiling point of at least 100 degrees Celsius accounting for at least 70 percent by mass of the ink,
wherein the wiper blade includes nitrile rubber containing at least 30 percent by mass of acrylonitrile, 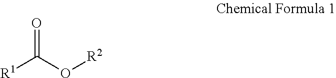
where R¹ and R² each independently represent a linear or branched, saturated or unsaturated aliphatic alkyl group.

2. The method according to claim 1, wherein the wiper blade immersed in the ink has a swelling ratio of at most 25 percent.

3. The method according to claim 1, wherein the solvent mixture in the ink has a solubility parameter (SP) of at most 17.0 (J/cm³)^{0.5}.

4. A fluid discharging apparatus comprising:
an ink:
an inkjet print head to discharge the ink through nozzles; and
a wiper blade to rub an ink discharging surface of the inkjet print head,
wherein the ink is an oil-based ink comprising a coloring material and a solvent mixture, the solvent mixture comprising:
an ester-based solvent represented by the following Chemical Formula 1 accounting for 5 to 70 percent by mass of the organic solvents; and
a saturated hydrocarbon solvent accounting for 20 to 80 percent by mass of the organic solvents,
wherein the solvent mixture includes organic solvents having a boiling point of at least 100 degrees Celsius accounting for at least 70 percent by mass of the ink,
wherein the wiper blade includes nitrile rubber containing at least 30 percent by mass of acrylonitrile, 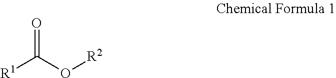
where R¹ and R² each independently represent a linear or branched, saturated or unsaturated aliphatic alkyl group.

5. The apparatus according to claim 4, wherein the wiper blade immersed in the ink has a swelling ratio of at most 25 percent.

6. The apparatus according to claim 4, wherein the solvent mixture in the ink has a solubility parameter (SP) of at most 17.0 (J/cm³)^{0.5}.
